(19) United States
(12) Patent Application Publication
(10) Pub. No.: US 2011/0122067 A1
(43) Pub. Date: May 26, 2011

(54) DISPLAY DEVICE, IMAGE FORMING APPARATUS, ELECTRONIC DEVICE, AND DISPLAY METHOD FOR A DISPLAY DEVICE

(75) Inventor: Yoshifumi OKABAYASHI, Osaka (JP)

(73) Assignee: KYOCERA MITA CORPORATION, Osaka (JP)

(21) Appl. No.: 12/946,173

(22) Filed: Nov. 15, 2010

(30) Foreign Application Priority Data
Nov. 26, 2009 (JP) 2009-268552

(51) Int. Cl. G06F 3/02; G06F 3/048

(52) U.S. Cl. 345/168; 715/773

(57) ABSTRACT

Provided is display device, including: an operation display section; a layout switching key; and a control section for controlling, based on an operation of the layout switching key, the operation display section to display therein one of a first key layout screen on which characters or symbols that can be input are assigned to a plurality of input keys and a second key layout screen on which the characters or symbols on the first key layout screen are partially assigned to the plurality of input keys, and controlling a plurality of first input keys and a plurality of second input keys to be switched over on the second key layout screen, the plurality of first input keys in order to narrow down the characters or symbols that can be input, the plurality of second input keys being displayed by an operation through one of the plurality of first input keys.

This application is based upon and claims the benefit of priority from the corresponding Japanese Patent Application No. 2009-268552 filed on Nov. 26, 2009, the entire contents of which are incorporated herein by reference.

### BACKGROUND OF THE INVENTION

1. Field of the Invention

The present invention relates to a display device which has a touch panel function and can receive a key input through an operation thereof, and also relates to an image forming apparatus and an electronic device which are equipped with a display device. Further, the present invention relates to a display method for a display device.

2. Description of Related Art

In recent years, various electric appliances typified by a portable information equipment are equipped with a display device including a touch panel section on a front surface thereof. Some image forming apparatuses such as a copier, a printer, a facsimile machine, and a scanner are also equipped with a display device including a touch panel section on a front surface thereof. Such display devices generally receive operations such as a character input and command execution when an input key displayed on a screen provided with the touch panel section is touched directly by a hand or touched by an auxiliary input tool such as a stylus.

In particular, the display device that receives a character input causes a large number of keys corresponding to characters that can be input to be displayed on a screen thereof. For example, there is known a conventional portable information equipment is equipped with a display device (liquid crystal display) having a screen provided with a touch panel section in which “hiragana” keys corresponding to the Japanese fifty hiragana characters are arranged and displayed so that an input can be received through each of the “hiragana” keys. The “hiragana” keys corresponding to the Japanese fifty hiragana characters are formed in such a manner that five character keys are arranged in a vertical direction and ten character keys are arranged in a horizontal direction.

The display device of the above conventional portable information equipment has all the “hiragana” keys corresponding to the Japanese fifty hiragana characters displayed on almost the entire screen, which creates a fear that the individual input keys themselves may be designed to have a considerably small size. Moreover, in a case where, as with the portable information equipment, the touch panel section of the display device itself has a relatively small size, it is highly probable that the individual input keys may be designed to have a much smaller size.

On such a display device, there is a probability that an adjacent key to a desired input key may be erroneously depressed even if an auxiliary input tool such as a stylus is used, which may be considerably inconvenient and unpleasant particularly for elderly people, those who have physical handicaps such as an injury or a disease in their hands or fingers, and those who have a problem with their eyesight.

### SUMMARY OF THE INVENTION

The present invention has been made in view of the above-mentioned problem, and an object thereof is to provide a display device which facilitates a key input by suppressing an occurrence of a problem that an adjacent key to a desired input key may be erroneously depressed in a touch panel section while taking universal design into consideration. Another object of the present invention is to provide an image forming apparatus and an electronic device which are equipped with such a display device and offer excellent usability. Further another object of the present invention is to provide a display method for a display device which facilitates a key input by suppressing an occurrence of a problem that a key may be erroneously depressed.

In order to solve the above-mentioned problem, a display device of the present invention includes: an operation display section including a touch panel section for displaying a plurality of input keys on a screen and receiving a key operation; a layout switching key for switching over a layout of the plurality of input keys; and a control section for controlling, based on an operation of the layout switching key, the operation display section to display therein one of a first key layout screen on which characters or symbols that can be input are displayed so as to be assigned to the plurality of input keys and a second key layout screen on which the characters or symbols on the first key layout screen that can be input are partially displayed so as to be assigned to the plurality of input keys, and controlling a plurality of first input keys and a plurality of second input keys to be switched over on the second key layout screen, the plurality of first input keys being arranged in order to narrow down the characters or symbols that can be input, the plurality of second input keys being displayed by an operation through one of the plurality of first input keys and arranged in order to further narrow down the narrowed-down characters or symbols that can be input.

According to this configuration, the input keys displayed on the second key layout screen are smaller in number than the input keys displayed on the first key layout screen.

Further, in the display device configured as described above, the control section controls, when one of the plurality of first input keys is depressed, the operation display section to display therein the plurality of second input keys corresponding to the one of the plurality of first input keys.

Further, in the display device configured as described above, the display device further includes a numeric keypad located outside the operation display section, in which: the plurality of first input keys are respectively attached with numerals corresponding to numerals of the numeric keypad and labeled with the numerals; and the control section controls, when one of the numerals of the numeric keypad is held depressed for a fixed time period or longer, the operation display section to display therein the plurality of second input keys corresponding to one of the plurality of first input keys that is attached with the one of the numerals of the numeric keypad.

The numeric keypad is also used for a numeric input. Therefore, according to this configuration, the second input keys can be displayed in the operation display section by using the numeric keypad.

Note that, the above-mentioned “fixed time period” represents an arbitrary time period determined in advance, and may be set to a time period ranging from, for example, 0.5 seconds to 1 second. The “fixed time period” is set to “0.5 seconds” in embodiments described later, but the present invention is not limited to the time period of 0.5 seconds. Further, the term “fixed time period” is used in a plurality of passages of the description of the following means, but the same time period is not always used therein.

Further, in the display device configured as described above, the display device further includes a lower-case character display key for switching over display between characters respectively corresponding to the plurality of first input keys and the plurality of second input keys and lower-case characters corresponding thereto, in which the control section controls, when the lower-case character display key is held depressed for a fixed time period or longer in a display state of the plurality of first input keys, the operation display section to display therein the input keys labeled with the lower-case characters respectively corresponding to the plurality of first input keys, and controls, when the lower-case character display key is held depressed for a fixed time period or longer in a display state of the plurality of second input keys, the operation display section to display therein the input keys labeled with the lower-case characters respectively corresponding to the plurality of second input keys.

According to this configuration, a key provided to the display device in order to cause another operation to be executed can be used as the lower-case character display key.

Further, in the display device configured as described above, the display device further includes: a lower-case character display key for switching over display between characters respectively corresponding to the plurality of first input keys and the plurality of second input keys and lower-case characters corresponding thereto; a numeric keypad located outside the operation display section, wherein: the plurality of first input keys are respectively attached with numerals corresponding to numerals of the numeric keypad and labeled with the numerals; and the control section controls, when one of the plurality of first input keys and the lower-case character display key are simultaneously held depressed for a fixed time period or longer in a display state of the plurality of first input keys, the operation display section to display therein the input keys labeled with the lower-case characters respectively corresponding to the plurality of second input keys corresponding to the one of the plurality of first input keys, and controls, when one of numerals of the numeric keypad and the lower-case character display key are simultaneously held depressed for a fixed time period or longer in the display state of the plurality of first input keys, the operation display section to display therein the input keys labeled with the lower-case characters respectively corresponding to the plurality of second input keys corresponding to one of the plurality of first input keys attached with the one of the numerals of the numeric keypad.

Further, in the display device configured as described above, when there exists no lower-case character corresponding to one of the plurality of first input keys and the plurality of second input keys at the operation through the lower-case character display key, the control section controls the operation display section to gray out and display therein the one of the plurality of first input keys and the plurality of second input keys.

According to this configuration, in general, the user can recognize at a glance that there exists no lower-case character corresponding to a narrow-down key that is grayed out and displayed.

Further, in the display device configured as described above, the control section controls, when there has been no key input for a fixed time period or longer in a display state of the plurality of second input keys, the screen to be changed to a display state of the plurality of first input keys.

According to this configuration, the screen returns to the display state of the plurality of first input keys automatically after the elapse of the fixed time period.

Further, in the display device configured as described above, at least part of the plurality of input keys displayed on the second key layout screen, to which the characters or symbols that can be input are assigned, each have a larger size than the plurality of input keys displayed on the first key layout screen, to which the characters or symbols that can be input are assigned.

Further, in the display device configured as described above, at least part of the plurality of input keys displayed on the second key layout screen, to which the characters or symbols that can be input are assigned, each have a wider pitch between adjacent input keys than the plurality of input keys displayed on the first key layout screen, to which the characters or symbols that can be input are assigned.

Further, in the display device configured as described above, the characters or symbols respectively corresponding to the plurality of first input keys and the plurality of second input keys can be arbitrarily selected.

According to this configuration, the input keys displayed on the second key layout screen become much smaller in number.

Further, in the display device configured as described above, the control section controls, when a switchover is performed between a display state of the plurality of first input keys and a display state of the plurality of second input keys, the input key to which one of the character and the symbol that is shared by respective input keys is assigned to be displayed in the same position.

Further, in the display device configured as described above, the control section controls, when the touch panel section that has received the key operation cannot identify the input key on the first key layout screen, the operation display section to display therein the second key layout screen.

According to this configuration, the display is automatically changed to the second key layout screen upon erroneous depression of the input key on the first key layout screen.

Further, in the display device configured as described above, the control section controls, after an elapse of a predetermined time period since the second key layout screen is displayed because the input key cannot be identified on the first key layout screen, the operation display section to display therein the first key layout screen.

According to this configuration, even when the display is automatically changed to the second key layout screen due to the erroneous depression of the input key on the first key layout screen, the display is automatically changed to the first key layout screen after the key operation is finished on the second key layout screen.

Note that, the above-mentioned “predetermined time period” represents an arbitrary time period determined in advance, and may be set to a time period ranging from, for example, three seconds to five seconds. The “predetermined time period” is set to “three seconds” in the embodiments described later, but the present invention is not limited to the time period of three seconds. Further, the term “fixed time period” is used in a plurality of passages of the description of the above-mentioned means, but represents a different time period from “predetermined time period”.

Further, according to other aspects of the present invention, an image forming apparatus and an electronic device are each equipped with the display device configured as described above.

Further, a display method for a display device according to the present invention includes: receiving an operation of a layout switching key for switching over a layout of a plurality of input keys displayed in a touch panel section of an operation display section; controlling, based on the operation of the layout switching key, the operation display section to display therein one of a first key layout screen on which characters or symbols that can be input are displayed so as to be assigned to the plurality of input keys and a second key layout screen on which the characters or symbols on the first key layout screen that can be input are partially displayed so as to be assigned to the plurality of input keys; controlling a plurality of first input keys to be displayed on the second key layout screen, the plurality of first input keys being arranged in order to narrow down the characters or symbols that can be input; and controlling a plurality of second input keys to be displayed on the second key layout screen based on an operation through one of the plurality of first input keys, the plurality of second input keys being arranged in order to further narrow down the narrowed-down characters or symbols that can be input.

According to this method, the input keys displayed on the second key layout screen are smaller in number than the input keys displayed on the first key layout screen.

Further features and advantages of the present invention will become apparent from the description of embodiments given below.

### BRIEF DESCRIPTION OF THE DRAWINGS

In the accompanying drawings:

FIG. 1 is a schematic vertically-sectional front view of an image forming apparatus equipped with a display device according to a first embodiment of the present invention;

FIG. 2 is a block diagram illustrating a configuration of the image forming apparatus of FIG. 1;

FIG. 3 is a front view of an operation panel (display device) of the image forming apparatus illustrated in FIG. 1;

FIG. 4 is a front view of an operation display section displaying a first key layout screen of the operation panel illustrated in FIG. 3;

FIG. 5 is a front view of the operation display section displaying a second key layout screen of the operation panel illustrated in FIG. 3;

FIG. 6 is a front view of the same operation display section as that of FIG. 5, which illustrates a state in which a plurality of second input keys are displayed;

FIG. 7 is a front view of the same operation display section as that of FIG. 5, which illustrates a state in which a plurality of first input keys are displayed in a different manner from FIG. 5;

FIG. 8 is a front view of the same operation display section as that of FIG. 6, which illustrates a state in which a plurality of second input keys different from those of FIG. 6 are displayed;

FIG. 9 is a front view of an operation display section of an operation panel (display device) according to a second embodiment of the present invention, which illustrates a state in which a plurality of first input keys are displayed;

FIG. 10 is a front view of the same operation display section as that of FIG. 9, which illustrates a state in which a plurality of second input keys are displayed;

FIG. 11 is a front view of an operation display section of an operation panel (display device) according to a third embodiment of the present invention, which illustrates a state in which a plurality of second input keys are displayed;

FIG. 12 is a flowchart illustrating an operation regarding an erroneous operation performed on a first key layout screen of an operation panel (display device) according to a fourth embodiment of the present invention;

FIG. 13 is a front view of an operation display section of an operation panel (display device) according to a fifth embodiment of the present invention;

FIG. 14 is a front view of the operation display section illustrated in FIG. 13 displaying a second key layout screen, which illustrates a state in which a plurality of first input keys are displayed;

FIG. 15 is a front view of the same operation display section as that of FIG. 14, which illustrates a state in which a plurality of second input keys are displayed;

FIG. 16 is a front view of an electronic device (cellular phone unit) equipped with a display device according to a sixth embodiment of the present invention;

FIG. 17 is a perspective view of the cellular phone unit illustrated in FIG. 16, which illustrates a state in which the cellular phone unit is folded; and

FIG. 18 is a front view of the display device of the cellular phone unit illustrated in FIG. 17.

### DETAILED DESCRIPTION OF PREFERRED EMBODIMENTS

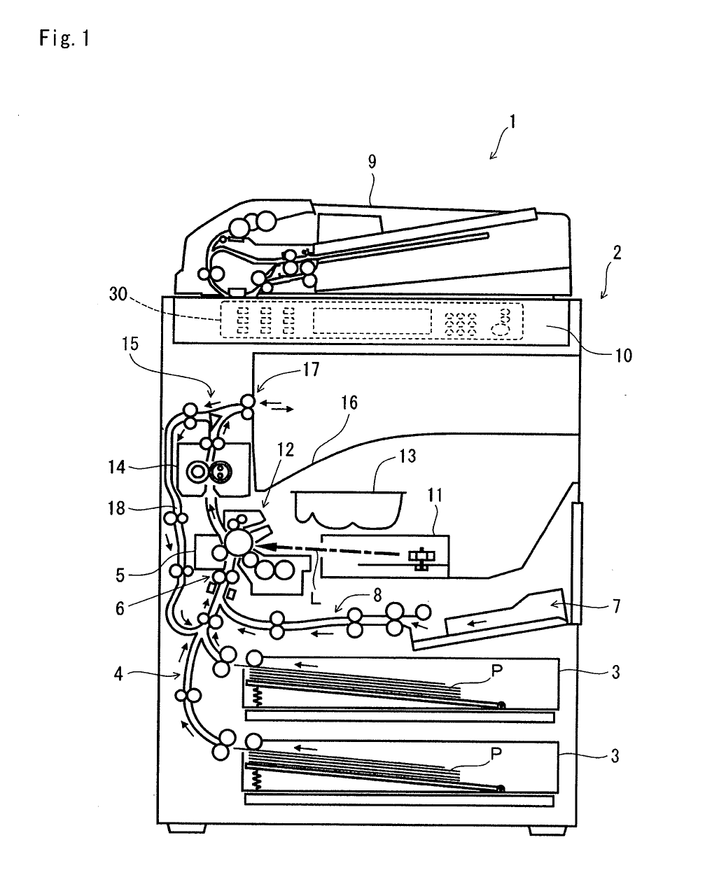

Hereinafter, embodiments of the present invention are described with reference to FIGS. 1 to 18.

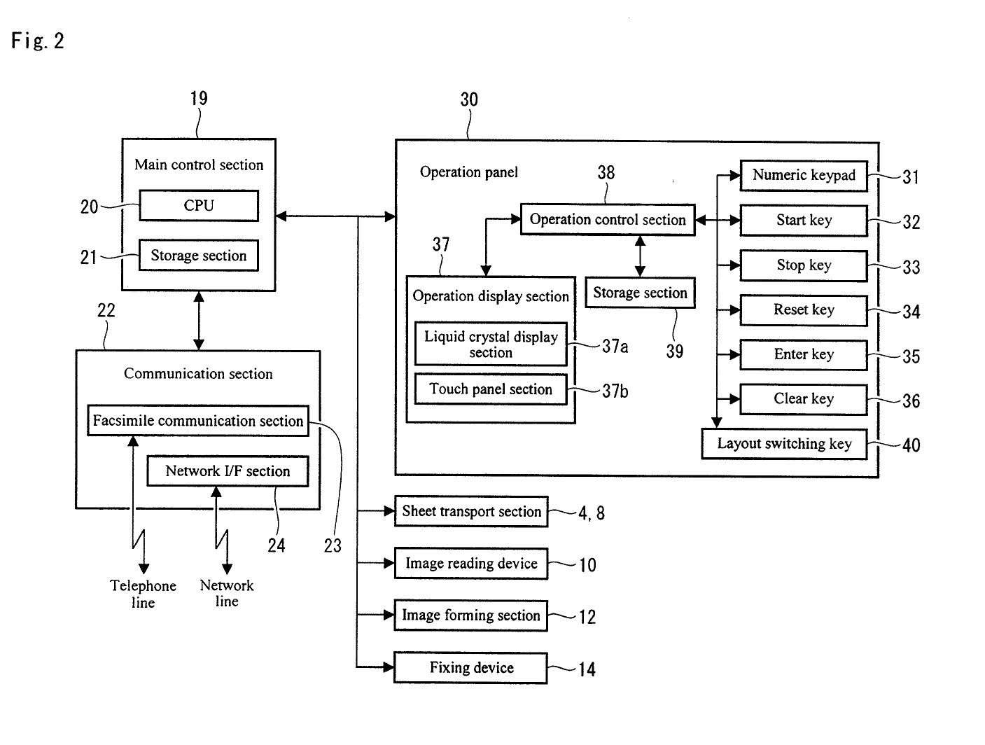

First, with regard to an image forming apparatus equipped with a display device according to a first embodiment of the present invention, an image output operation is described by referencing FIGS. 1 and 2 to describe an outline structure and configuration thereof. FIG. 1 is a schematic vertically-sectional front view of the image forming apparatus, and FIG. 2 is a block diagram illustrating the configuration of the image forming apparatus. In FIG. 1, the solid arrows indicate a transport path and a transport direction of a paper sheet, and the dashed-dotted arrow indicates a laser beam L.

As illustrated in FIG. 1, an image forming apparatus 1 includes a main body 2 inside which sheet feeding cassettes 3 are located in a lower stage. The sheet feeding cassette 3 receives therein a stack of paper sheets P such as cut sheets to be subjected to printing. The paper sheets P are separately sent out one by one toward the top left side of the sheet feeding cassette 3 of FIG. 1. The sheet feeding cassette 3 can be pulled out horizontally from a front surface side of the main body 2.

A first sheet transport section 4 is provided inside the main body 2 on the left side of the sheet feeding cassette 3. The first sheet transport section 4 is formed substantially vertically along a left side surface of the main body 2. The first sheet transport section 4 receives the paper sheet P sent out from the sheet feeding cassette 3, and transports the paper sheet P to a transferring section 5 vertically upward along the left side surface of the main body 2.

Note that, a registration roller pair 6 is provided in a sheet transport path on an immediate upstream side of the transferring section 5. The registration roller pair 6 sends out the paper sheet P heading toward the transferring section 5 at a favorable timing while correcting skewing so that a transfer of a toner image can be accurately executed.

A manual sheet feeding section 7 is provided above the sheet feeding cassettes 3 in a portion near a right side surface of the main body 2 which is opposite to the left side surface along which the first sheet transport section 4 is formed. Paper sheets having a size that is not contained in the sheet feeding cassettes 3 or cardboards, OHP sheets, or other such paper sheets that are to be manually fed one by one are placed in the manual sheet feeding section 7.

A second sheet transport section 8 is provided on the left side of the manual sheet feeding section 7. The second sheet transport section 8 is located immediately above the sheet feeding cassettes 3, extends substantially horizontally from the manual sheet feeding section 7 to the first sheet transport section 4, and joins the first sheet transport section 4. Then, the second sheet transport section 8 receives the paper sheet sent out from the manual sheet feeding section 7, and transports the paper sheet substantially horizontally to the first sheet transport section 4.

Meanwhile, an original transport device 9 is provided on a top surface of the main body 2 of the image forming apparatus 1, and an image reading device 10 is provided below the original transport device 9. In a case where of performing copying of an original on which an image including characters, graphics, and patterns is drawn, a user places the original on the original transport device 9. The original transport device 9 sends out the original separately one by one, and the image reading device 10 reads image data on the original.

The reading of the original image, that is, the start of image formation, is executed by using an operation panel 30 serving as the display device provided in an upper portion of the main body 2 on a front surface side of the image reading device 10. The operation panel 30 receives settings from the user, the settings including printing condition settings on a type and a size of the paper sheet to be used for the printing, enlargement/reduction, and availability of double-side printing, and a facsimile transmission destination setting. Note that, a structure of the operation panel 30 is described later in detail.

Information on the image data on the original is sent to an exposure device 11 located above the second sheet transport section 8 in a center portion of the main body 2. The exposure device 11 applies the laser beam L controlled based on the image data toward an image forming section 12.

The image forming section 12 and the transferring section 5 are provided above the first sheet transport section 4 on the left side of the exposure device 11. In the image forming section 12, an electrostatic latent image of the original image is formed by the laser beam L applied by the exposure device 11, and the toner image is developed from the electrostatic latent image. The image forming section 12 is replenished with toner from a toner container 13 provided above the exposure device 11. The transferring section 5 transfers the toner image formed in the image forming section 12 onto the paper sheet P sent at a timing determined by the registration roller pair 6.

A fixing device 14 is provided above the transferring section 5. The paper sheet P that bears the unfixed toner image in the transferring section 5 is sent to the fixing device 14 for fixing the toner image by being heated and pressurized by a heat roller and a pressure roller.

A sheet guiding device 15 is provided above the fixing device 14. In a case where double-side printing is not performed, the paper sheet P delivered from the fixing device 14 is delivered from the sheet guiding device 15 to an in-chassis sheet delivery section 16 provided inside a chassis of the image forming apparatus 1.

A delivery port portion through which the paper sheet P is delivered from the sheet guiding device 15 toward the in-chassis sheet delivery section 16 functions as a switchback section 17. In the case where double-side printing is performed, a transport direction of the paper sheet P delivered from the fixing device 14 is switched over in the switchback section 17. Then, the paper sheet P passes the sheet guiding device 15, is sent downward through a sheet transport path 18 for double-side printing provided on the left side of the fixing device 14 and the left side of the transferring section 5, and is again sent to the transferring section 5 via the first sheet transport section 4.

As illustrated in FIG. 2, for operation control of an entire apparatus, the image forming apparatus 1 further includes, inside the main body 2 thereof, a main control section 19 formed of a CPU 20, a storage section 21, and other such electronic components (not shown). The main control section 19 uses the CPU 20 as a central processing unit to realize a series of image forming operations by controlling components such as the image reading device 10, the image forming section 12, and the fixing device 14 based on a program and data stored in and input to the storage section 21. The main control section 19 receives condition settings regarding the operation of the image forming apparatus 1 from the user through the operation panel 30.

The image forming apparatus 1 further includes a communication section 22 for exchanging image data with an external apparatus by using a telephone line or network line. The communication section 22 includes a facsimile communication section 23 for performing communications by using a telephone line and a network interface (I/F) section 24 for performing communications by using a network line.

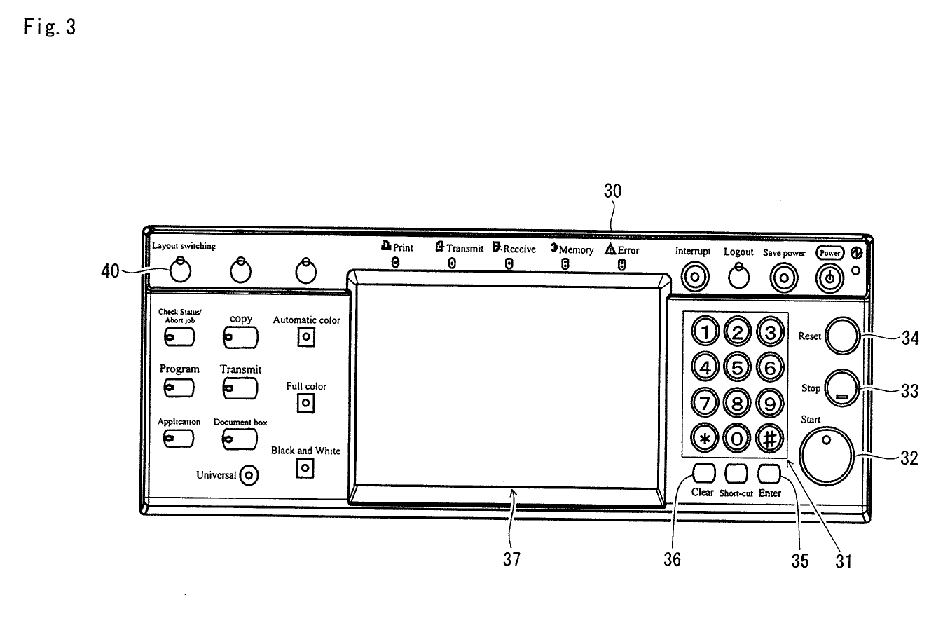

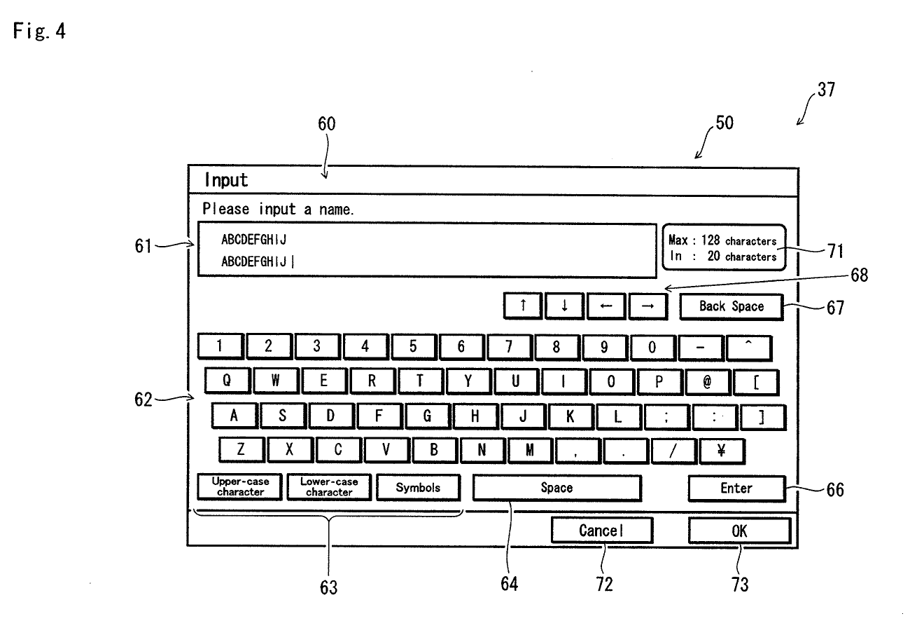

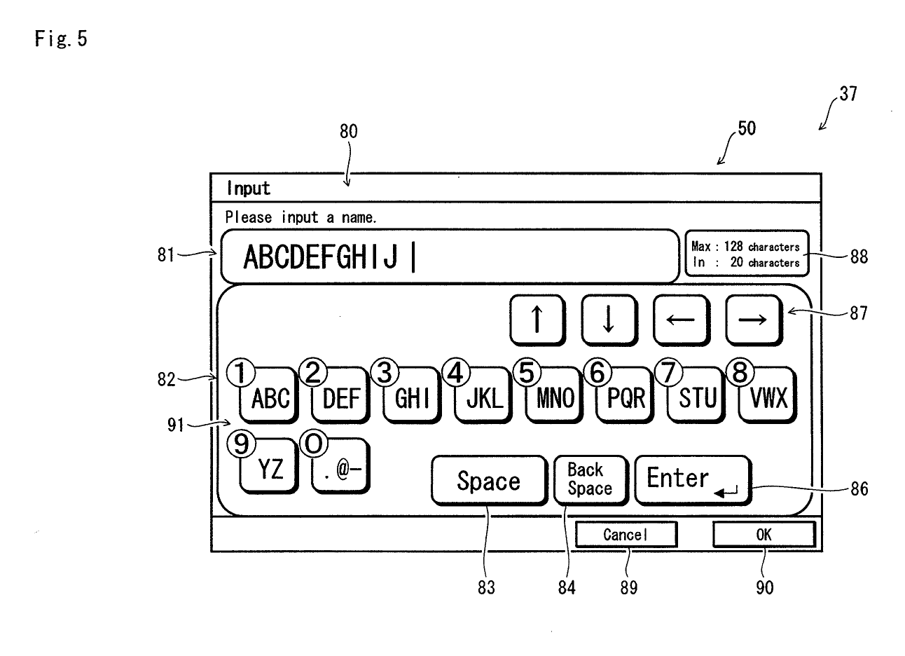

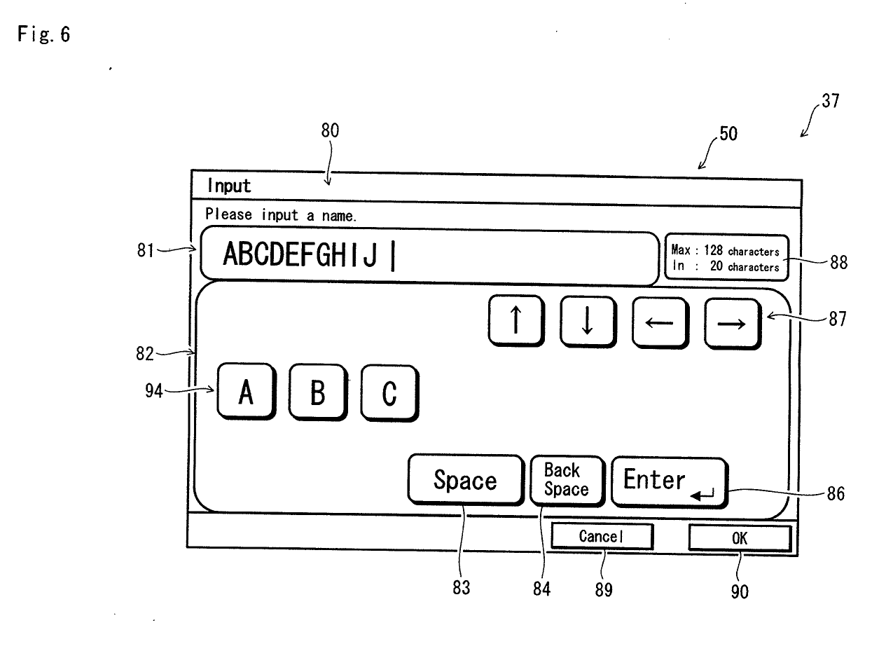

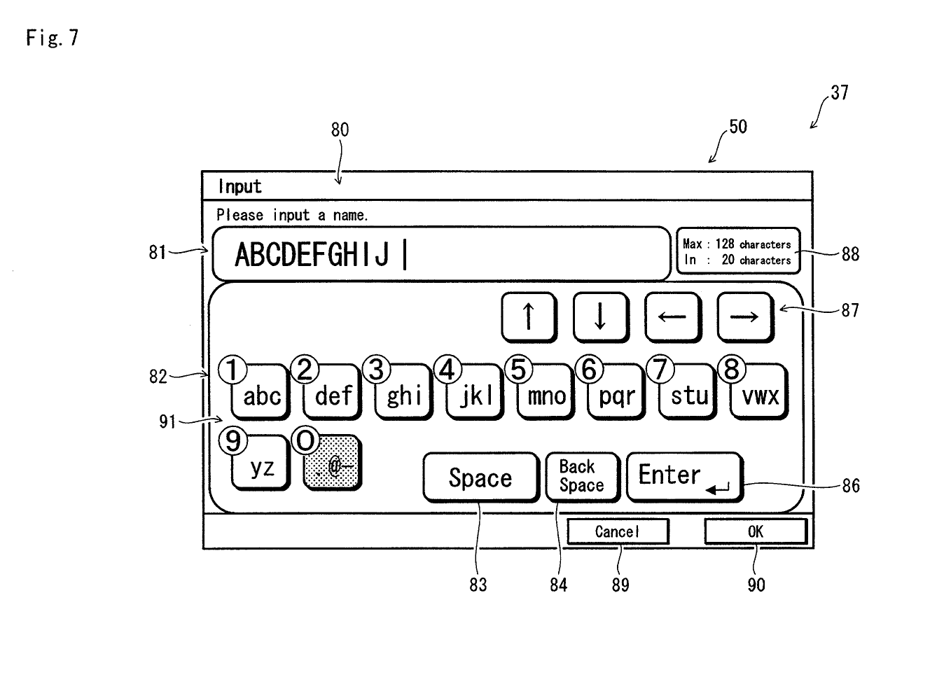

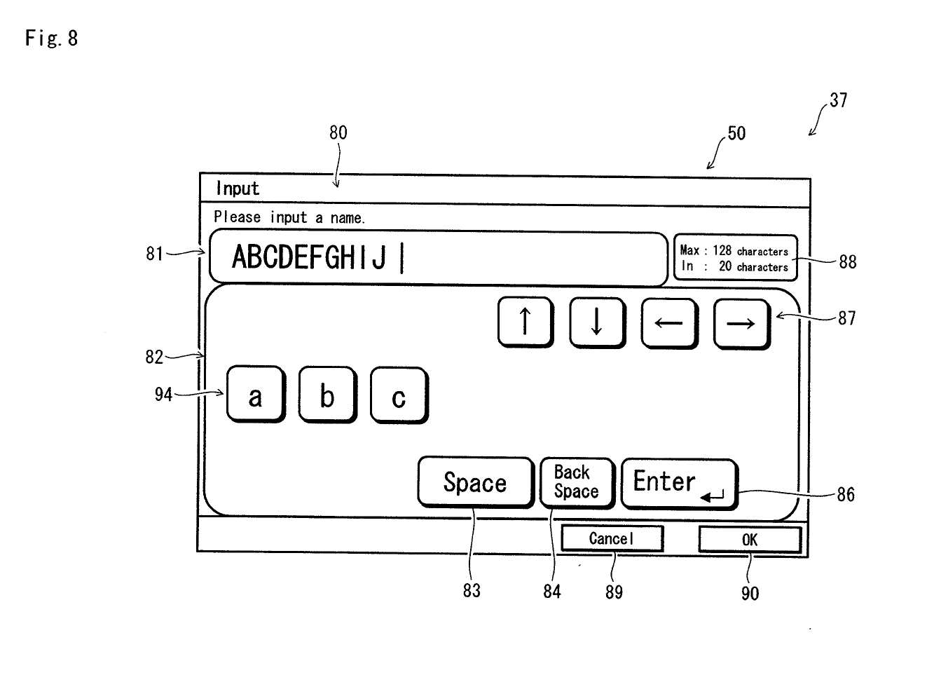

Next, in addition to FIG. 2, FIGS. 3 to 8 are referenced to describe the detailed configuration of the operation panel 30 serving as the display device. FIG. 3 is a front view of the operation panel 30 of the image forming apparatus 1, FIG. 4 is a front view of an operation display section displaying a first key layout screen of the operation panel 30, FIG. 5 is a front view of the operation display section displaying a second key layout screen of the operation panel 30, FIG. 6 is a front view of the same operation display section as that of FIG. 5, which illustrates a state in which a plurality of second input keys are displayed, FIG. 7 is a front view of the same operation display section as that of FIG. 5, which illustrates a state in which a plurality of first input keys are displayed in a different manner from FIG. 5, and FIG. 8 is a front view of the same operation display section as that of FIG. 6, which illustrates a state in which a plurality of second input keys different from those of FIG. 6 are displayed.

As illustrated in FIGS. 2 and 3, the operation panel 30 includes a numeric keypad 31, a start key 32, a stop key 33, a reset key 34, an enter key 35, a clear key 36, an operation display section 37, an operation control section 38, a storage section 39, and a layout switching key 40.

As illustrated in FIG. 3, the numeric keypad 31, the start key 32, the stop key 33, the reset key 34, the enter key 35, and the clear key 36 are arranged in an area of a right side portion of the operation panel 30. The numeric keypad 31 is a set of keys for receiving a numeric input which are labeled with the numerals “0” to “9” and the symbols “*” and “#”. The start key 32 is a key for receiving an instruction to start each kind of setting. The stop key 33 is a key for receiving an instruction to stop each kind of operation. The reset key 34 is a key for receiving an instruction to reset each kind of operation. The enter key 35 is a key that functions in the same manner as a so-called “OK” instruction for permitting each kind of setting. The clear key 36 is a key for erasing an input numeral, character, or symbol.

As illustrated in FIG. 3, the operation display section 37 is located in a center portion of the operation panel 30. As illustrated in FIG. 2, the operation display section 37 includes a liquid crystal display section 37a and a touch panel section 37b. The liquid crystal display section 37a displays a plurality of keys and items regarding inputs, settings, instructions, and the like by using a liquid crystal. The touch panel section 37b is located above the liquid crystal display section 37a in a superimposed manner, and receives a selection of an item displayed in the liquid crystal display section 37a and an input of a key displayed therein when being touched by the user with his/her finger or the like.

The operation control section 38 is a control device formed of an IC (not shown) and other such electronic components (not shown), for controlling the operation panel 30 based on the control of the main control section 19. According to a control instruction issued from the main control section 19, the operation control section 38 controls the operation display section 37 to perform the displaying by setting the type and the layout of items and input keys that are to be displayed based on a program and data stored in the storage section 21 or the storage section 39. Further, the operation control section 38 identifies the input key that has been operated by the user based on information obtained from the numeric keypad 31, the start key 32, or other such key or the touch panel section 37b, and transmits a signal of the input key to the main control section 19 as an operation instruction issued from the user.

Here, the operation panel 30 can display a character input screen 50 illustrated in FIG. 4 in the operation display section 37. The character input screen 50 is displayed at a time of, for example, editing a screen of an address book used for transmitting the image data to the external apparatus via the communication section 22.

The character input screen 50 includes a first key layout screen 60 illustrated in FIG. 4 and a second key layout screen 80 illustrated in FIG. 5. Characters or symbols that can be input are displayed on the first key layout screen 60 so as to be assigned to a plurality of input keys. Meanwhile, the characters or symbols on the first key layout screen 60 that can be input are partially displayed on the second key layout screen 80 so as to be assigned to the plurality of input keys. At least part of the plurality of input keys displayed on the second key layout screen 80 each have a larger size and a wider pitch between adjacent input keys than the plurality of input keys displayed on the first key layout screen 60.

A switchover between the first key layout screen 60 and the second key layout screen 80 can be performed by depressing the layout switching key 40 of the operation panel 30 as illustrated in FIG. 3. Based on the operation of the layout switching key 40, the operation control section 38 displays one of the first key layout screen 60 and the second key layout screen 80 on the operation display section 37 by switching over the display therebetween.

As illustrated in FIG. 4, arranged on the first key layout screen 60 are an input character display section 61, a keyboard section 62, keyboard section switching keys 63, a space key 64, an enter key 66, a back space key 67, cursor keys 68, a character count display section 71, a cancel key 72, and an OK key 73.

The input character display section 61 is provided in an upper portion of the first key layout screen 60. The input character display section 61 is a display area for input characters, in which two rows of characters are displayed.

The keyboard section 62 is provided to have a relatively wide area substantially in a center portion of the first key layout screen 60. The plurality of input keys to which the characters or symbols that can be input are assigned are arranged and displayed in the keyboard section 62.

The keyboard section switching keys 63 are provided immediately below the keyboard section 62. The keyboard section switching keys 63 are used for switching over the labels of the respective input keys of the keyboard section 62 among “upper-case character”, “lower-case character”, and “symbols”. Note that, in an initial state, the respective input keys of the keyboard section 62 are labeled with upper-case characters.

The space key 64 and the enter key 66 are each provided immediately below the keyboard section 62. The space key 64 is a key for inputting a space. The enter key 66 is a key for inputting a line break during a character input with respect to the input character display section 61 or determining the character input.

The back space key 67 and the cursor keys 68 are each provided below the input character display section 61 between the input character display section 61 and the keyboard section 62. The back space key 67 is a key for deleting a character immediately before a cursor in the input character display section 61 to push leftward the cursor and a character on the right side of the cursor. The cursor keys 68 include four keys labeled with arrows pointing in four directions of up, down, left, and right. The cursor keys 68 are keys for moving the cursor in the respective directions in the input character display section 61.

The character count display section 71 is provided on the right side of the input character display section 61. In the character count display section 71, a count limit of characters to be input to the input character display section 61 is displayed in the upper row, and a count of characters being currently input is displayed in the lower row.

The cancel key 72 and the OK key 73 are each located in a right side portion at the bottom of the first key layout screen 60. The cancel key 72 is used to cancel the selected input, and the OK key 73 is used to permit a command input.

As illustrated in FIG. 5, arranged on the second key layout screen 80 are an input character display section 81, a keyboard section 82, a space key 83, a back space key 84, an enter key 86, cursor keys 87, a character count display section 88, a cancel key 89, and an OK key 90.

The input character display section 81 is provided in an upper portion of the second key layout screen 80. The input character display section 81 is a display area for input characters, in which one row of characters is displayed. The input character display section 81 has substantially the same display area as that of the input character display section 61 of the first key layout screen 60 in which two rows of characters are displayed, and therefore has characters displayed in a larger size than the input character display section 61.

The keyboard section 82 is provided to have a relatively wide area substantially in a center portion of the second key layout screen 80. A plurality of input keys to which the characters or symbols that can be input are assigned are arranged and displayed in the keyboard section 82. Then, the keyboard section 82 is formed of an input key group of a plurality of first input keys 91.

The plurality of first input keys 91 are associated and labeled with twenty-six characters of the alphabet which are divided in groups of approximately three characters. In other words, the plurality of first input keys 91 go on with the labels “ABC”, “DEF”, and so forth, but end with the two-character label “YZ” only at the end. Further, the plurality of first input keys 91 also include an input key associated and labeled with three symbols of “. (period)”, “@”, and “-”. The plurality of first input keys 91 are arranged in order to narrow down the characters or symbols that can be input. Further, the plurality of first input keys 91 are attached with the numerals “0” to “9” respectively in top left portions thereof.

When one of the plurality of first input keys 91 associated with “three alphabetic characters”, “two alphabetic characters”, and “three symbols” illustrated in FIG. 5 is depressed, the operation control section 38 controls the keyboard section 82 to display therein, as illustrated in FIG. 6, a plurality of second input keys 94 that correspond to the one of the plurality of first input keys 91. Further, when one of the numerals “0” to “9” of the numeric keypad 31 illustrated in FIG. 3 is held depressed for a fixed time period or longer, the operation control section 38 controls the keyboard section 82 to display therein the plurality of second input keys 94 corresponding to the first input key 91 attached with the depressed numeral of the numeric keypad 31. In this case, the fixed time period is set to, for example, 0.5 seconds, and is stored in the storage section 39.

The plurality of second input keys 94 are each associated and labeled with “one of the alphabetic characters” that correspond to the depressed first input key 91. For example, in a case where the key labeled with “ABC” is depressed among the plurality of first input keys 91 illustrated in FIG. 5, or in a case where the numeral “1” of the numeric keypad 31 is held depressed for the fixed time period or longer, the plurality of second input keys 94 labeled with “A”, “B”, and “C” are displayed in the keyboard section 82 as illustrated in FIG. 6. The plurality of second input keys 94 are obtained by the narrowing down performed by the first input key 91, and are arranged in order to further narrow down ones of the characters or symbols that can be input which are displayed in the keyboard section 82 of the second key layout screen 80.

Here, the clear key 36 illustrated in FIG. 3 also functions as a lower-case character display key used when an operation is performed on the second key layout screen 80 illustrated in FIG. 5. The clear key 36 serving as the lower-case character display key is a key for switching over the display between characters respectively corresponding to the first input keys 91 and the second input keys 94 and the lower-case characters corresponding thereto.

When the clear key 36 is held depressed for the fixed time period or longer in a display state of the plurality of first input keys 91 illustrated in FIG. 5, the operation control section 38 controls the keyboard section 82 to display therein input keys labeled with the lower-case characters respectively corresponding to the plurality of first input keys 91 as illustrated in FIG. 7. Further, when the clear key 36 is held depressed for the fixed time period or longer in a display state of the plurality of second input keys 94 illustrated in FIG. 6, the operation control section 38 controls the keyboard section 82 to display therein input keys labeled with the lower-case characters respectively corresponding to the plurality of second input keys 94 as illustrated in FIG. 8. In those cases, the fixed time period is set to, for example, 0.5 seconds, and is stored in the storage section 39.

Note that, when there exists no lower-case character corresponding to one of the plurality of first input keys 91 and the plurality of second input keys 94 at the operation through the clear key 36 serving as the lower-case character display key, the operation control section 38 controls the keyboard section 82 to gray out and display therein the one of the plurality of first input keys 91 and the plurality of second input keys 94. For example, in the display state of the plurality of first input keys 91, the input key labeled with the three symbols “.”, “@”, and “-” is grayed out as illustrated in FIG. 7.

When one of the plurality of first input keys 91 and the clear key 36 serving as the lower-case character display key are simultaneously held depressed for the fixed time period or longer in the display state of the plurality of first input keys 91 illustrated in FIG. 5, the operation control section 38 controls the keyboard section 82 to display therein, as illustrated in FIG. 8, the input keys labeled with the lower-case characters respectively corresponding to the plurality of second input keys 94 corresponding to the one of the plurality of first input keys 91. Further, when one of the numerals “0” to “9” of the numeric keypad 31 and the clear key 36 are simultaneously held depressed for the fixed time period or longer in the display state of the plurality of first input keys 91 illustrated in FIG. 5, the operation control section 38 controls the keyboard section 82 to display therein, as illustrated in FIG. 8, the input keys labeled with the lower-case characters respectively corresponding to the plurality of second input keys 94 corresponding to the first input key 91 attached with the depressed numeral of the numeric keypad 31. In those cases, the fixed time period is set to, for example, 0.5 seconds, and is stored in the storage section 39.

Note that, when there has been no key input for the fixed time period or longer in the display state of the plurality of second input keys 94, the operation control section 38 controls the second key layout screen 80 to change the display state of the plurality of second input keys 94 to the display state of the plurality of first input keys 91. In this case, the fixed time period is set to, for example, one second, and is stored in the storage section 39.

The space key 83, the back space key 84, and the enter key 86 are provided immediately below the keyboard section 82, the cursor keys 87 are provided immediately above the keyboard section 82, and the character count display section 88 is provided on the right side of the input character display section 81. Further, the cancel key 89 and the OK key 90 are each located in a right side portion at the bottom of the second key layout screen 80. Those keys have the same functions as those of the first key layout screen 60, and hence description thereof is omitted.

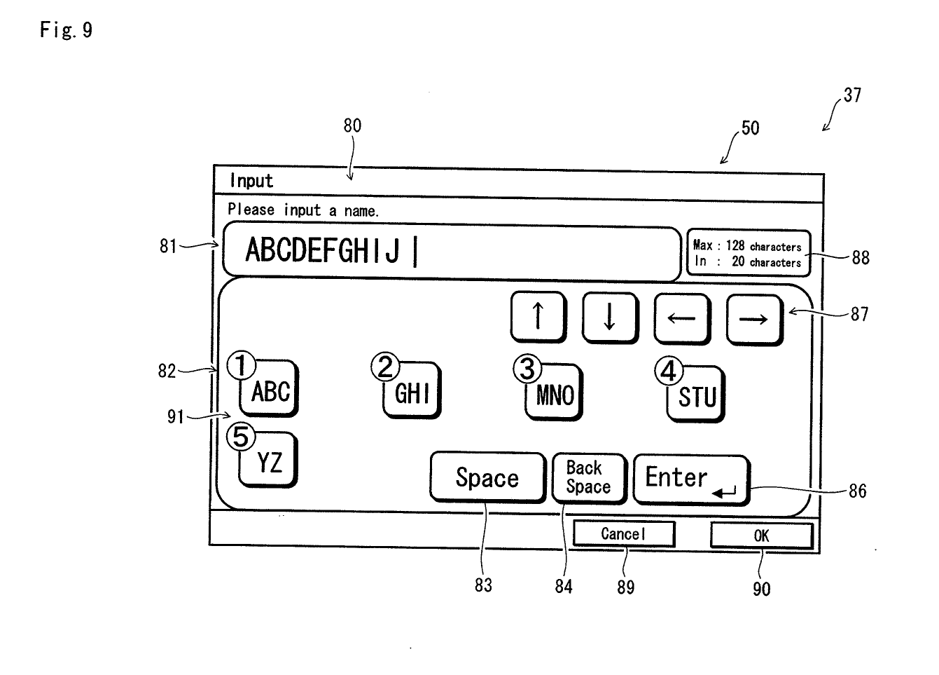

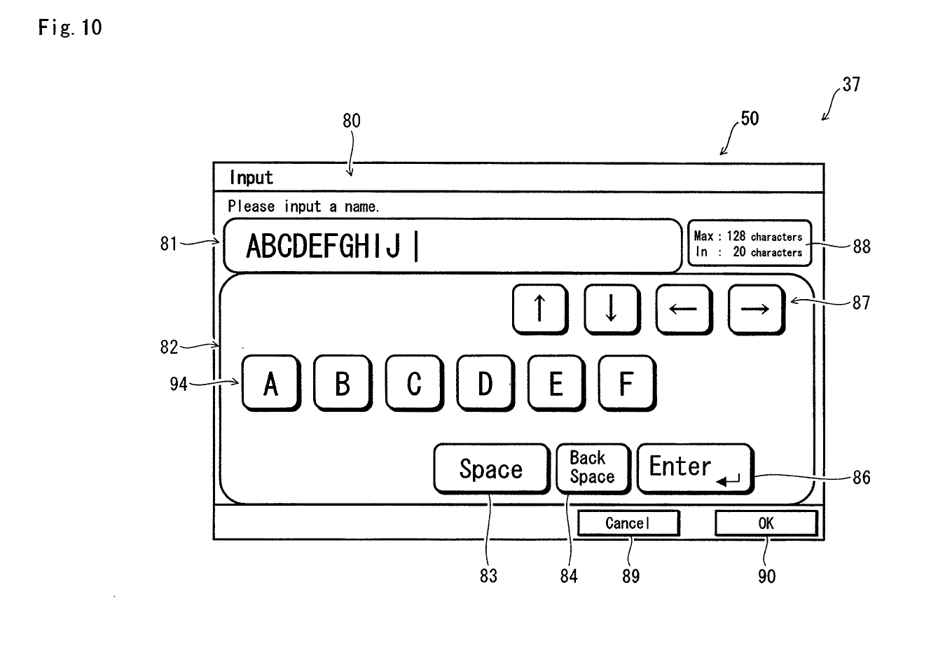

Next, FIGS. 9 and 10 are referenced to describe a display device according to a second embodiment of the present invention. FIG. 9 is a front view of an operation display section of an operation panel serving as the display device, which illustrates a state in which a plurality of first input keys are displayed, and FIG. 10 is a front view of the same operation display section as that of FIG. 9, which illustrates a state in which a plurality of second input keys are displayed. Note that, the basic structure and configuration of this embodiment are the same as those of the above-mentioned first embodiment described with reference to FIGS. 1 to 8, and hence the same components as those of the first embodiment are denoted by the same reference symbols, while description thereof is omitted.

The character input screen 50 of the operation panel 30 serving as the display device according to the second embodiment includes the second key layout screen 80 illustrated in FIG. 9. The plurality of first input keys 91 to which the characters or symbols that can be input are assigned are partially arranged and displayed in the keyboard section 82 of the second key layout screen 80.

Every other key that is labeled with three or two alphabetic characters is displayed among the first input keys 91 associated and labeled with the twenty-six characters of the alphabet which are divided in groups of approximately three characters and the three symbols. In other words, the keys labeled with “ABC”, “GHI”, “MNO”, “STU”, and “YZ” are displayed, while the keys labeled with “DEF”, “JKL”, “PQR”, “VWX”, and “.@-” are not displayed. In such a manner, the first input key 91 allows an arbitrary selection of the corresponding character or symbol. Accordingly, the input keys displayed on the second key layout screen 80 become much smaller in number, which can widen the pitch between the adjacent input keys. Further, the plurality of first input keys 91 are attached with the numerals “1” to “5” respectively in top left portions thereof.

When one of the plurality of first input keys 91 illustrated in FIG. 9 is depressed, the operation control section 38 controls the keyboard section 82 to display therein, as illustrated in FIG. 10, the plurality of second input keys 94 corresponding to the one of the plurality of first input keys 91. Further, when one of the numerals “1” to “5” of the numeric keypad 31 illustrated in FIG. 3 is held depressed for a fixed time period or longer, the operation control section 38 controls the keyboard section 82 to display therein the plurality of second input keys 94 corresponding to the first input key 91 attached with the depressed numeral of the numeric keypad 31. In this case, the fixed time period is set to, for example, 0.5 seconds, and is stored in the storage section 39.

The plurality of second input keys 94 are each associated and labeled with “six alphabetic characters” that start with the characters with which the depressed first input key 91 is labeled. For example, in a case where the key labeled with “ABC” is depressed among the plurality of first input keys 91 illustrated in FIG. 9, or in the case where the numeral “1” of the numeric keypad 31 is held depressed for the fixed time period or longer, the plurality of second input keys 94 labeled with “A”, “B”, “C”, “D”, “E”, and “F” are displayed in the keyboard section 82 as illustrated in FIG. 10. Note that, in the case of “YZ”, the plurality of second input keys 94 labeled with “Y”, “Z”, “.”, “@”, and “-” are displayed in the keyboard section 82. In such a manner, the plurality of second input keys 94 allows an arbitrary selection of the corresponding character or symbol similarly to the plurality of first input keys 91.

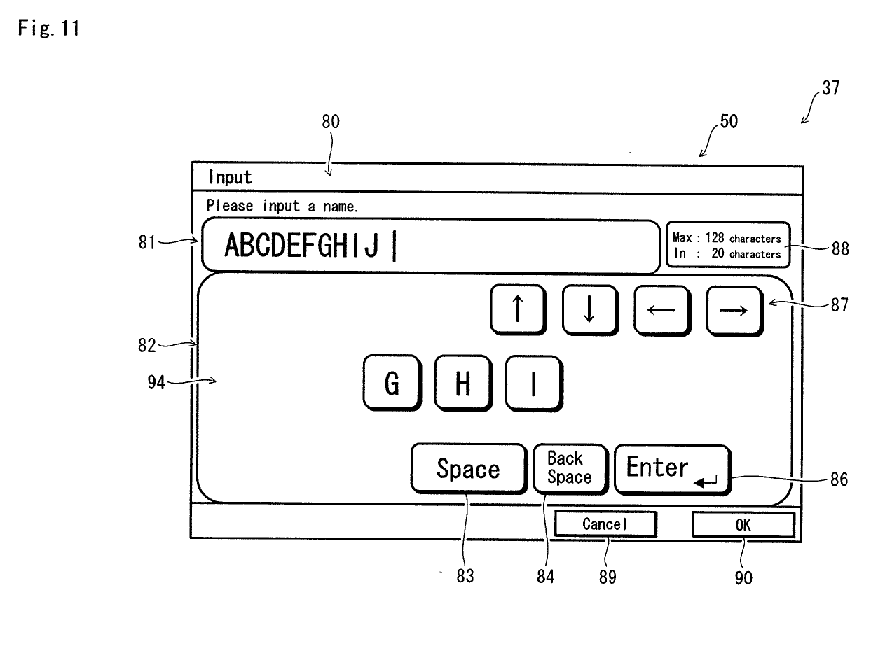

Next, FIG. 11 is referenced to describe a display device according to a third embodiment of the present invention. FIG. 11 is a front view of an operation display section of an operation panel serving as the display device, which illustrates a state in which a plurality of second input keys are displayed. Note that, the basic structure and configuration of this embodiment are the same as those of the above-mentioned first embodiment described with reference to FIGS. 1 to 8, and hence the same components as those of the first embodiment are denoted by the same reference symbols, while description thereof is omitted.

The character input screen 50 of the operation panel 30 serving as the display device according to the third embodiment includes the second key layout screen 80 illustrated in FIG. 11. The plurality of second input keys 94 displayed by the operation of the first input key 91 are arranged in the keyboard section 82 of the second key layout screen 80.

The plurality of second input keys 94 labeled with “G”, “H”, and “I” corresponding to “GHI” with which the depressed first input key 91 is labeled are displayed in the keyboard section 82. Here, the second input key 94 labeled with “G” is displayed in the same position as the first input key 91 labeled with “GHI” in the display state of the plurality of first input keys 91 illustrated in FIG. 5, which improves operability of the second key layout screen 80.

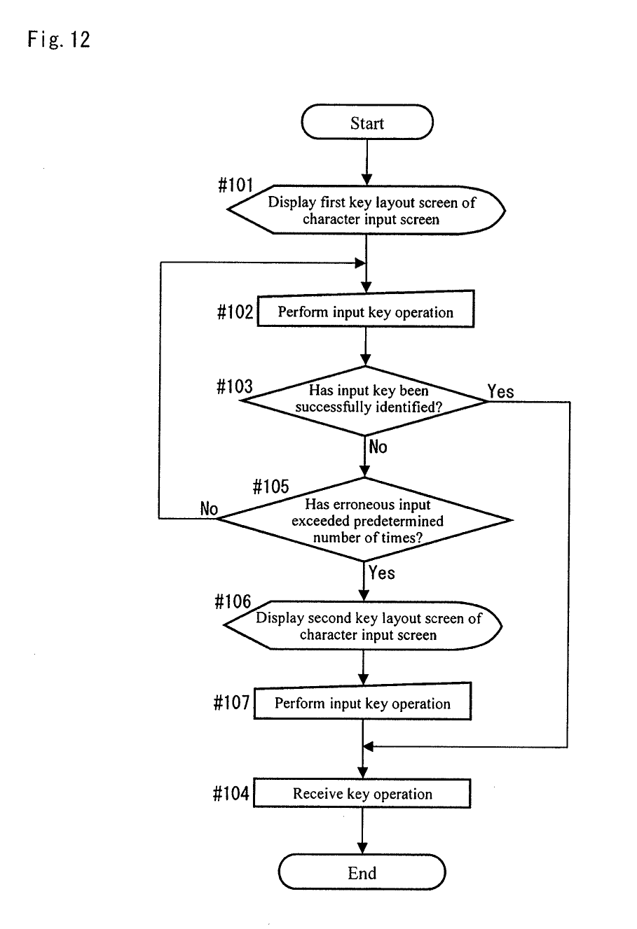

Next, FIG. 12 is referenced to describe a display device according to a fourth embodiment of the present invention. FIG. 12 is a flowchart illustrating an operation regarding an erroneous operation performed on the first key layout screen of an operation panel serving as the display device. Note that, the basic structure and configuration of this embodiment are the same as those of the above-mentioned first embodiment described with reference to FIGS. 1 to 8, and hence the same components as those of the first embodiment are denoted by the same reference symbols, while drawings and description thereof are omitted.

With regard to the operation panel 30 serving as the display device according to the fourth embodiment, as illustrated in FIG. 12, the operation control section 38 controls the operation display section 37 to display therein the first key layout screen 60 of the character input screen 50 according to a request made by the user (Step #101).

Subsequently, when an input key operation is performed by the user (Step #102), the operation control section 38 determines whether or not the touch panel section 37b that has received the key operation has successfully identified the input key (Step #103). When the input key has been successfully identified (Yes in Step #103), the operation control section 38 receives the key operation (Step #104), and is again brought to a standby mode for the input key operation (end in FIG. 12).

On the other hand, when the input key has not been successfully identified in Step #103 because, for example, the user has depressed a plurality of keys simultaneously or has depressed a portion in which no key is displayed (No in Step #103), the operation control section 38 then determines whether or not such an erroneous input has exceeded a predetermined number of times (Step #105). The predetermined number of times is set to, for example, three times in a row, and is stored in the storage section 39. When the erroneous input has been determined but when the erroneous input has not reached the predetermined number of times (No in Step #105), the operation control section 38 again receives an input key operation performed by the user (Step #102).

Then, when the erroneous input has exceeded the predetermined number of times because, for example, the input key cannot be identified continuously (Yes in Step #105), the operation control section 38 controls the operation display section 37 to display therein the second key layout screen 80 in place of the first key layout screen 60 (Step #106). After that, the user performs an input key operation through the second key layout screen 80 (Step #107). Then, the operation control section 38 receives the key operation (Step #104), and is again brought to the standby mode for the input key operation (end in FIG. 12). According to this configuration, the display is automatically changed to the second key layout screen 80 upon an erroneous depression of the input key on the first key layout screen 60, which allows a much easier key input.

Note that, the operation control section 38 controls the operation display section 37 to display therein the second key layout screen 80 in Step #106, and after the elapse of a predetermined time period, controls the operation display section 37 to display therein the first key layout screen 60. In this case, the predetermined time period is set to, for example, three seconds, and is stored in the storage section 39. According to this configuration, even when the display is automatically changed to the second key layout screen 80 due to the erroneous depression of the input key on the first key layout screen 60, when the key operation is finished on the second key layout screen 80, the display is automatically changed to the first key layout screen 60, which is convenient when the operation is to be continued on the first key layout screen 60.

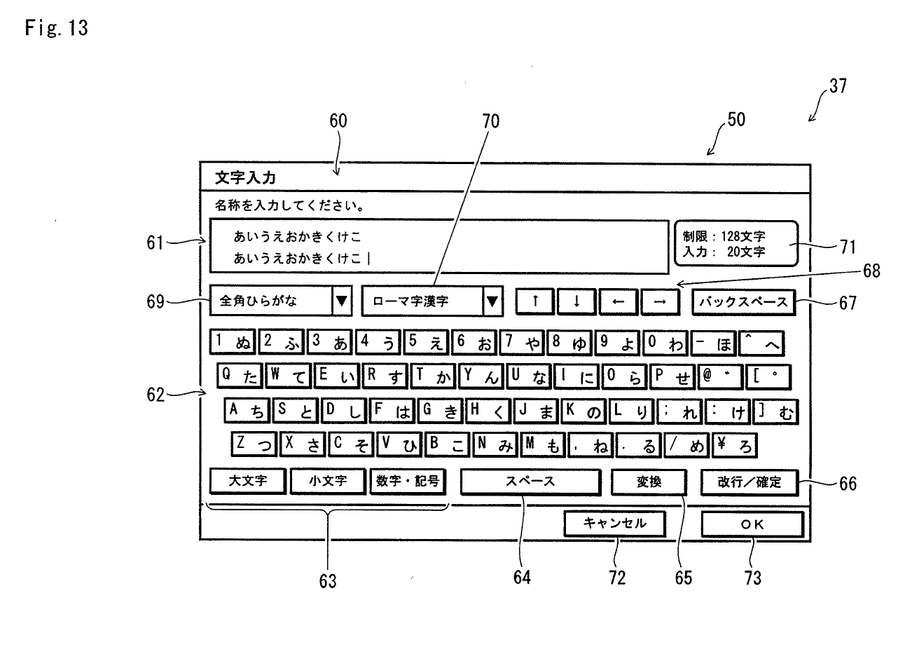

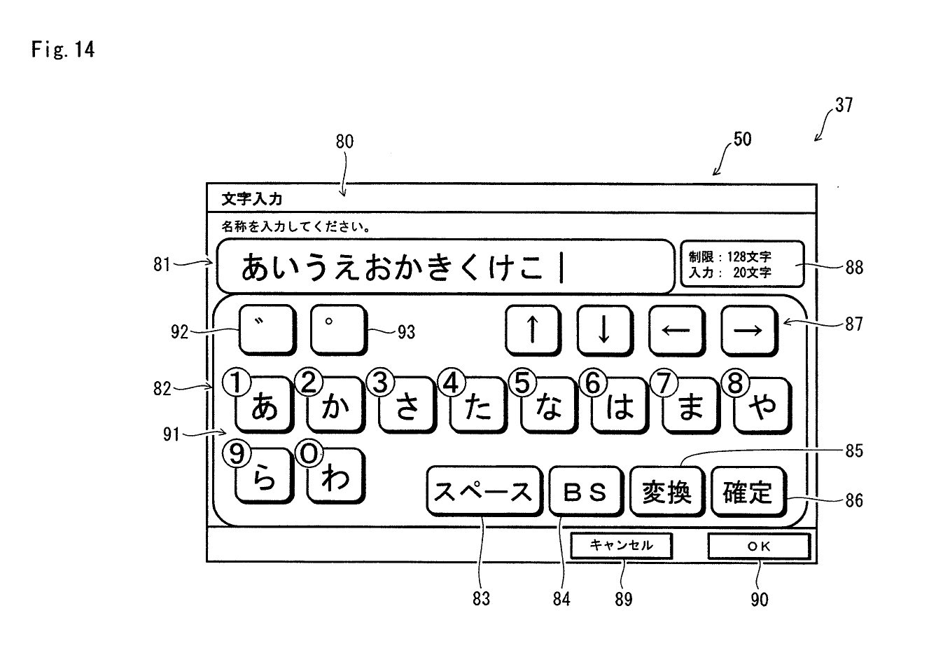

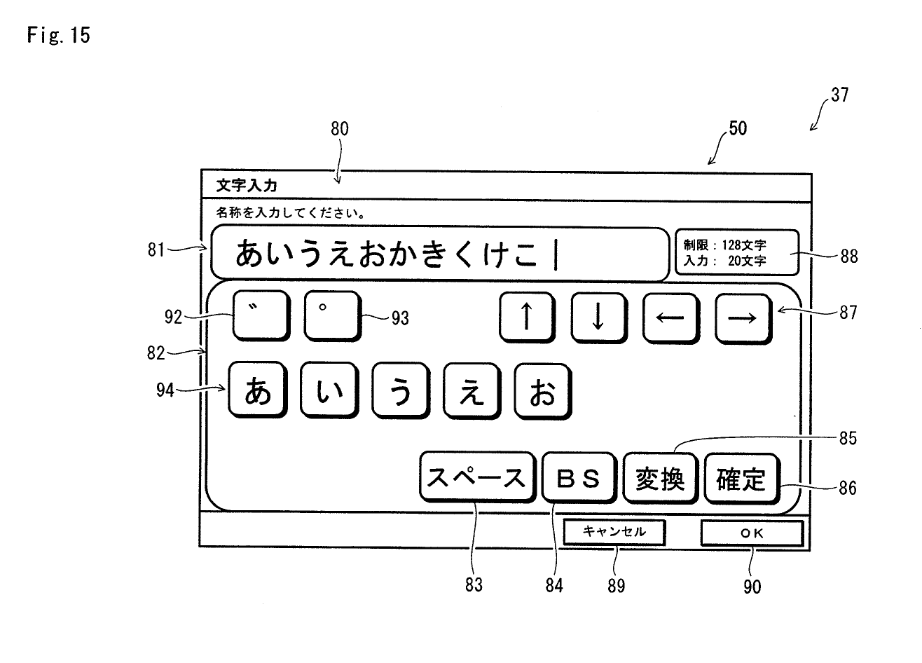

Next, FIGS. 13 to 15 are referenced to describe a display device according to a fifth embodiment of the present invention. FIG. 13 is a front view of an operation display section of an operation panel serving as the display device, FIG. 14 is a front view of the operation display section illustrated in FIG. 13 displaying a second key layout screen, which illustrates a state in which a plurality of first input keys are displayed, and FIG. 15 is a front view of the same operation display section as that of FIG. 14, which illustrates a state in which a plurality of second input keys are displayed. Note that, the basic structure and configuration of this embodiment are the same as those of the above-mentioned first embodiment described with reference to FIGS. 1 to 8, and hence description thereof is omitted by denoting the same components as those of the first embodiment with the same reference symbols.

The operation panel 30 serving as the display device according to the fifth embodiment is provided to the image forming apparatus 1 targeted at a user who uses Japanese, and as illustrated in FIG. 13, most of the characters on the character input screen 50 of the operation display section 37 are expressed in Japanese.

The character input screen 50 includes the first key layout screen 60 illustrated in FIG. 13 and the second key layout screen 80 illustrated in FIG. 14. Characters or symbols that can be input are displayed on the first key layout screen 60 so as to be assigned to the plurality of input keys. Meanwhile, the characters or symbols on the first key layout screen 60 that can be input are partially displayed on the second key layout screen 80 so as to be assigned to the plurality of input keys. The switchover between the first key layout screen 60 and the second key layout screen 80 can be performed by depressing the layout switching key 40 of the operation panel 30 as illustrated in FIG. 3.

As illustrated in FIG. 14, the keyboard section 82 of the second key layout screen 80 is provided to have a relatively wide area substantially in a center portion of the screen. The plurality of first input keys 91 to which the characters or symbols that can be input are assigned are partially arranged and displayed in the keyboard section 82.

The plurality of first input keys 91 are respectively associated and labeled with the head characters in the respective columns of the Japanese fifty-character syllabary (10 columns) of “hiragana” characters used in Japanese. The plurality of first input keys 91 are arranged in order to narrow down the characters or symbols that can be input. Further, the plurality of first input keys 91 are attached with the numerals “0” to “9” respectively in top left portions thereof.

When one of the plurality of first input keys 91 associated with “head characters in the respective columns of the Japanese fifty-character syllabary” as illustrated in FIG. 14 is depressed, the operation control section 38 controls the keyboard section 82 to display therein, as illustrated in FIG. 15, the plurality of second input keys 94 that correspond to the one of the plurality of first input keys 91. Further, when one of the numerals “0” to “9” of the numeric keypad 31 illustrated in FIG. 3 is held depressed for a fixed time period or longer, the operation control section 38 controls the keyboard section 82 to display therein the plurality of second input keys 94 corresponding to the plurality of first input keys 91 attached with the depressed numeral of the numeric keypad 31. In this case, the fixed time period is set to, for example, 0.5 seconds, and is stored in the storage section 39. The plurality of second input keys 94 are each associated and labeled with “one of the five characters in each row of the Japanese fifty-character syllabary” that corresponds to the one of the plurality of first input keys 91 that are depressed.

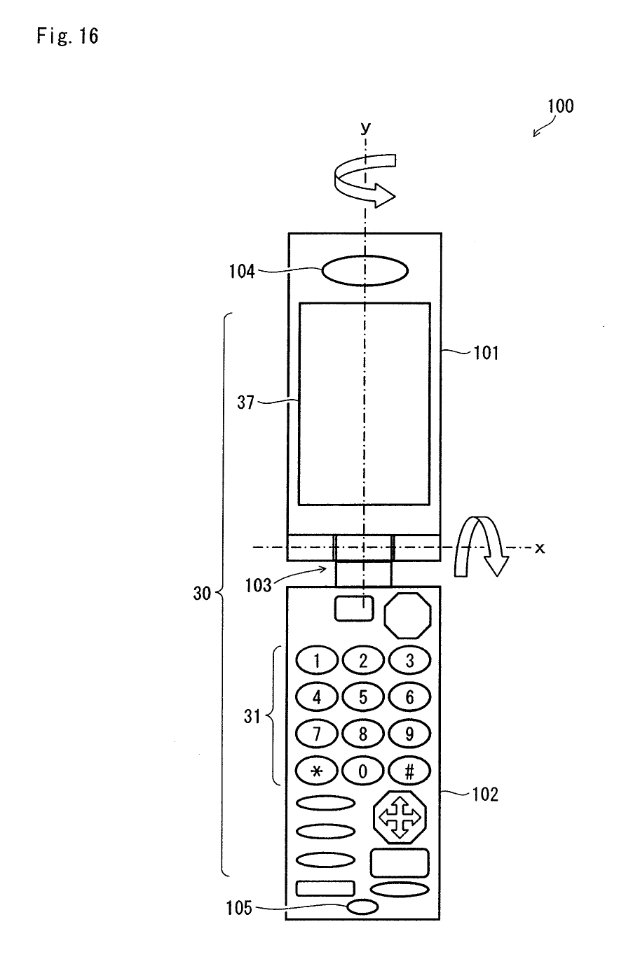

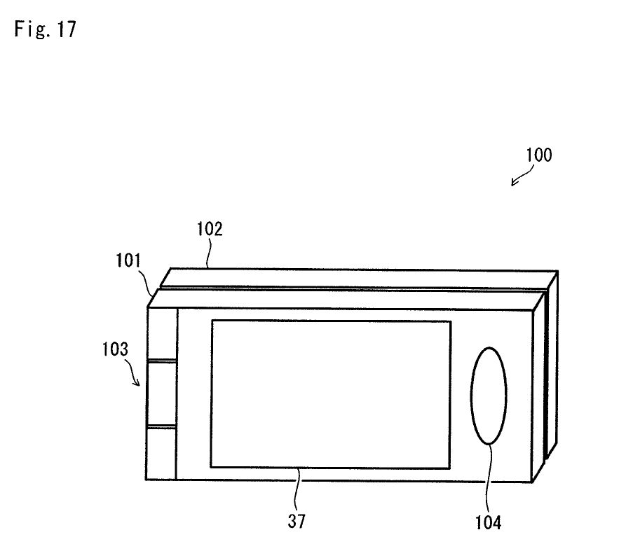

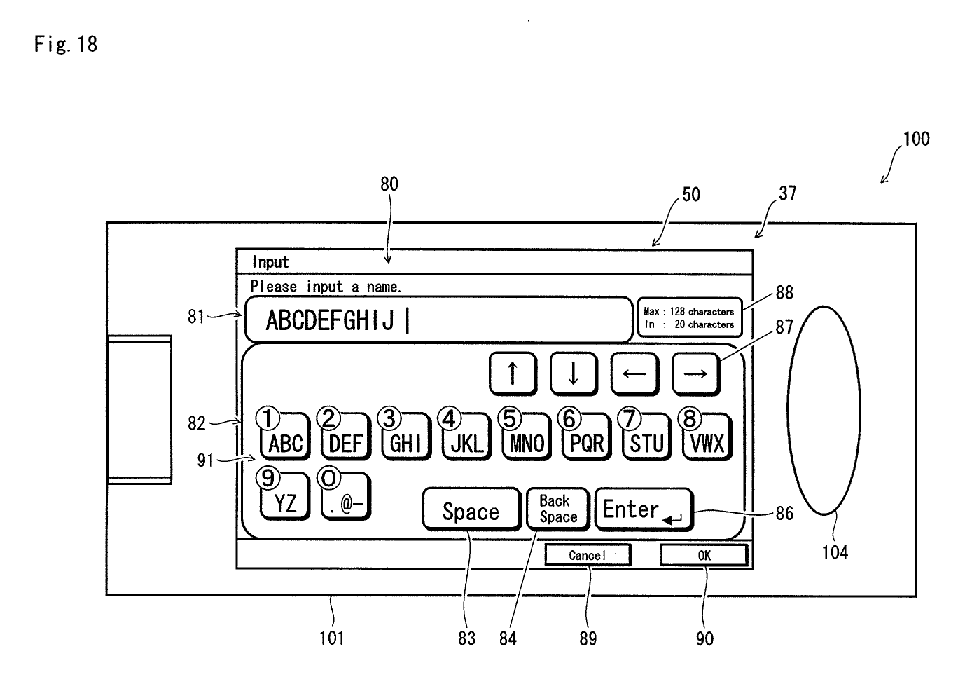

Next, FIGS. 16 to 18 are referenced to describe a structure of an electronic device equipped with a display device according to a sixth embodiment of the present invention. Note that, here, the description is made by taking a cellular phone unit as an example of the electronic device according to an embodiment of the present invention. FIG. 16 is a front view of the electronic device (cellular phone unit) equipped with the display device, FIG. 17 is a perspective view of the cellular phone unit, which illustrates a state in which the cellular phone unit is folded, and FIG. 18 is a front view of the display device of the cellular phone unit illustrated in FIG. 17. Further, the basic structure and configuration of the display device according to this embodiment are the same as those of the above-mentioned first embodiment, and hence the same components as those of the first embodiment are denoted by the same reference symbols, while drawings and description thereof are omitted.

As illustrated in FIG. 16, a cellular phone unit 100 is equipped with the operation panel 30 serving as the display device according to the sixth embodiment. In addition to the operation panel 30, the cellular phone unit 100 includes a first casing 101, a second casing 102, a hinge portion 103, an ear piece portion 104, and a mouth piece portion 105.

The first casing 101 and the second casing 102 both have a rectangular parallelepiped shape, and are coupled to each other by the hinge portion 103. The hinge portion 103 enables the first casing 101 to rotate in the x-axis and y-axis directions illustrated in FIG. 16 in terms of the second casing 102.

The rotation of the first casing 101 in the x-axis direction in terms of the second casing 102 allows the cellular phone unit to be folded with front surfaces of the two casings facing each other. Further, as illustrated in FIG. 17, the rotation of the first casing 101 in the x-axis and y-axis directions in terms of the second casing 102 allows the user to view the operation display section 37 provided to the front surface of the first casing 101 in a folded state.

In FIG. 16, the ear piece portion 104 is provided in an upper portion of the first casing 101, and the mouth piece portion 105 is provided a lower portion of the second casing 102. In telephone communications, the user hears a voice from the other party through the ear piece portion 104, while the user talks to the other party through the mouth piece portion 105.

The operation panel 30 includes the operation display section 37 provided to the front surface of the first casing 101 and the numeric keypad 31 provided to the front surface of the second casing 102. Arranged on the front surface of the second casing 102 are not only the numeric keypad 31 but also, for example, a power key (not shown), a call key (not shown), a mail key (not shown), an address book key (not shown), a clear key (not shown), a decision key (not shown), and a cursor key (not shown). Note that, as in the first embodiment, the operation display section 37 includes a liquid crystal display section and a touch panel section. The liquid crystal display section displays items regarding inputs, settings, instructions, and the like by using a liquid crystal. The touch panel section receives a selection of an item displayed in the liquid crystal display section and an input of a key displayed therein when being touched by the user with his/her finger or the like.

By operating, for example, the address book key (not shown) located on the operation panel 30, the character input screen 50 illustrated in FIG. 18 can be displayed in the operation display section 37. Note that, FIG. 18 illustrates a state in which the character input screen 50 is displayed in the operation display section 37 of the cellular phone unit 100 in the folded state illustrated in FIG. 17.

The character input screen 50 includes the first key layout screen 60 (not shown) and the second key layout screen 80 illustrated in FIG. 18. The keyboard section 82 of the second key layout screen 80 is formed of the input key group of the plurality of first input keys 91.

The plurality of first input keys 91 are associated and labeled with twenty-six characters of the alphabet which are divided in groups of approximately three characters. In other words, the plurality of first input keys 91 go on with the labels “ABC”, “DEF”, and so forth, but end with the two-character label “YZ” only at the end. Further, the plurality of first input keys 91 also include an input key associated and labeled with three symbols of “. (period)”, “@”, and “-”. The plurality of first input keys 91 are arranged in order to narrow down the characters or symbols that can be input. Further, the plurality of first input keys 91 are attached with the numerals “0” to “9” respectively in top left portions thereof.

When one of the plurality of first input keys 91 associated with “three alphabetic characters”, “two alphabetic characters”, and “three symbols” as illustrated in FIG. 18 is depressed, or when one of the numerals “0” to “9” of the numeric keypad 31 respectively attached to the plurality of first input keys 91 illustrated in FIG. 16 is held depressed for the fixed time period or longer, the plurality of second input keys 94 illustrated in FIG. 6 corresponding to the plurality of first input keys 91 are displayed in the keyboard section 82. Note that, as illustrated in FIG. 16, the numeric keypad 31 of the cellular phone unit 100 can be operated by opening the first casing 101 and the second casing 102.

According to the structures and configurations of the embodiments of the present invention, in the operation display section 37 including the touch panel section 37b, the input keys displayed on the second key layout screen 80 are smaller in number than the input keys displayed on the first key layout screen 60. Accordingly, the input keys displayed on the second key layout screen 80 can be displayed in the operation display section 37 in a larger size than the input keys displayed on the first key layout screen 60. It is also possible to widen the pitch between the adjacent input keys. This can suppress an occurrence of a problem that an adjacent key to a desired input key is erroneously depressed. As a result, it is possible to provide the operation panel 30 serving as the display device which allows an easy key input for elderly people, those who have physical handicaps such as an injury or a disease in their hands or fingers, and those who have a problem with their eyesight while taking universal design into consideration. In addition, it is possible to provide the image forming apparatus 1 which is equipped with such operation panel 30 and offers excellent usability.

In the above, the embodiments of the present invention have been described. However, the scope of the present invention is not limited thereto, and the present invention may be implemented by being subjected to various modifications without departing from the gist of the present invention.

For example, the above-mentioned embodiments of the present invention are each described by taking as an example the operation panel 30 (display device) with which the image forming apparatus 1 or the cellular phone unit 100 is equipped, but an apparatus to which the present invention is applied is not limited to the image forming apparatus and the cellular phone unit, and an electronic device including an address book, other than the image forming apparatus or the cellular phone unit, such as a PDA may be equipped with the display device according to each embodiment of the present invention.

Further, the image forming apparatus 1 equipped with the operation panel 30 is the image forming apparatus for monochrome printing which uses only black toner, but the image forming apparatus to which the present invention is applied is not limited to such a model, and the present invention may be applied to an image forming apparatus for color printing which includes an intermediate transferring belt and has a tandem system or a rotary rack system that allows the image formation with a plurality of colors superimposed one on another.

Further, the cellular phone unit 100 equipped with the operation panel 30 is the cellular phone unit that can be folded including the first casing 101 and the second casing 102, but the cellular phone unit to which the present invention is applied is not limited to such a model, and the present invention may be applied to a cellular phone unit that allows a first casing and a second casing to be caused to slide against each other or a cellular phone unit formed of a unitary casing without having such a deformation mechanism.

Further, the characters or symbols that can be input which are assigned to the plurality of input keys displayed in the keyboard section 62 of the first key layout screen 60 and the keyboard section 82 of the second key layout screen 80 are not limited to the alphabetic characters (Roman characters), the symbols (“.”, “@”, and “-”), and the Japanese “hiragana” characters, which are used in the above-mentioned embodiments, and the present invention may be applied to other characters or symbols.

What is claimed is:

1. A display device, comprising:
an operation display section comprising a touch panel section for displaying a plurality of input keys on a screen and receiving a key operation;
a layout switching key for switching over a layout of the plurality of input keys; and
a control section for controlling, based on an operation of the layout switching key, the operation display section to display therein one of a first key layout screen on which characters or symbols that can be input are displayed so as to be assigned to the plurality of input keys and a second key layout screen, on which the characters or symbols on the first key layout screen that can be input are partially displayed, so as to be assigned to the plurality of input keys, and controlling a plurality of first input keys and a plurality of second input keys to be switched over on the second key layout screen, the plurality of first input keys being arranged in order to narrow down the characters or symbols that can be input, the plurality of second input keys being displayed by an operation through one of the plurality of first input keys and arranged in order to further narrow down the narrowed-down characters or symbols that can be input.

2. A display device according to claim 1, wherein the control section controls, when one of the plurality of first input keys is depressed, the operation display section to display therein the plurality of second input keys corresponding to the one of the plurality of first input keys.

3. A display device according to claim 1, further comprising a numeric keypad located outside the operation display section, wherein:
the plurality of first input keys are respectively attached with numerals corresponding to numerals of the numeric keypad and labeled with the numerals; and
the control section controls, when one of the numerals of the numeric keypad is held depressed for a fixed time period or longer, the operation display section to display therein the plurality of second input keys corresponding to one of the plurality of first input keys that is attached with the one of the numerals of the numeric keypad.

4. A display device according to claim 1, further comprising a lower-case character display key for switching over display between characters respectively corresponding to the plurality of first input keys and the plurality of second input keys and lower-case characters corresponding thereto,
wherein the control section controls, when the lower-case character display key is held depressed for a fixed time period or longer in a display state of the plurality of first input keys, the operation display section to display therein the input keys labeled with the lower-case characters respectively corresponding to the plurality of first input keys, and controls, when the lower-case character display key is held depressed for a fixed time period or longer in a display state of the plurality of second input keys, the operation display section to display therein the input keys labeled with the lower-case characters respectively corresponding to the plurality of second input keys.

5. A display device according to claim 4, wherein the control section controls, when there exists no lower-case character corresponding to one of the plurality of first input keys and the plurality of second input keys at an operation through the lower-case character display key, the operation display section to gray out and display therein the one of the plurality of first input keys and the plurality of second input keys.

6. A display device according to claim 1, further comprising:
a lower-case character display key for switching over display between characters respectively corresponding to the plurality of first input keys and the plurality of second input keys and lower-case characters corresponding thereto;
a numeric keypad located outside the operation display section, wherein:
the plurality of first input keys are respectively attached with numerals corresponding to numerals of the numeric keypad and labeled with the numerals; and
the control section controls, when one of the plurality of first input keys and the lower-case character display key are simultaneously held depressed for a fixed time period or longer in a display state of the plurality of first input keys, the operation display section to display therein the input keys labeled with the lower-case characters respectively corresponding to the plurality of second input keys corresponding to the one of the plurality of first input keys, and controls, when one of numerals of the numeric keypad and the lower-case character display key are simultaneously held depressed for a fixed time period or longer in the display state of the plurality of first input keys, the operation display section to display therein the input keys labeled with the lower-case characters respectively corresponding to the plurality of second input keys corresponding to one of the plurality of first input keys attached with the ones of the numerals of the numeric keypad.

7. A display device according to claim 6, wherein the control section controls, when there exists no lower-case character corresponding to one of the plurality of second input keys at an operation through the lower-case character display key, the operation display section to gray out and display therein one of the plurality of first input keys corresponding to the one of the plurality of second input keys.

8. A display device according to claim 1, wherein the control section controls, when there has been no key input for a fixed time period or longer in a display state of the plurality of second input keys, the screen to be changed to a display state of the plurality of first input keys.

9. A display device according to claim 1, wherein at least part of the plurality of input keys displayed on the second key layout screen, to which the characters or symbols that can be input are assigned, each have a larger size than the plurality of input keys displayed on the first key layout screen, to which the characters or symbols that can be input are assigned.

10. A display device according to claim 1, wherein at least part of the plurality of input keys displayed on the second key layout screen, to which the characters or symbols that can be input are assigned, each have a wider pitch between adjacent input keys than the plurality of input keys displayed on the first key layout screen, to which the characters or symbols that can be input are assigned.

11. A display device according to claim 1, wherein the characters or symbols respectively corresponding to the plurality of first input keys and the plurality of second input keys can be arbitrarily selected.

12. A display device according to claim 1, wherein the control section controls, when a switchover is performed between a display state of the plurality of first input keys and a display state of the plurality of second input keys, the input key to which one of the character and the symbol that is shared by respective input keys is assigned to be displayed in the same position.

13. A display device according to claim 1, wherein the control section controls, when the touch panel section that has received the key operation cannot identify the input key on the first key layout screen, the operation display section to display therein the second key layout screen.

14. A display device according to claim 13, wherein the control section controls, after an elapse of a predetermined time period since the second key layout screen is displayed because the input key cannot be identified on the first key layout screen, the operation display section to display therein the first key layout screen.

15. An image forming apparatus, comprising the display device according to claim 1.

16. An electronic device, comprising the display device according to claim 1.

17. A display method for a display device, comprising:
receiving an operation of a layout switching key for switching over a layout of a plurality of input keys displayed in a touch panel section of an operation display section;
controlling, based on the operation of the layout switching key, the operation display section to display therein one of a first key layout screen on which characters or symbols that can be input are displayed so as to be assigned to the plurality of input keys and a second key layout screen on which the characters or symbols on the first key layout screen that can be input are partially displayed so as to be assigned to the plurality of input keys;
controlling a plurality of first input keys to be displayed on the second key layout screen, the plurality of first input keys being arranged in order to narrow down the characters or symbols that can be input; and
controlling a plurality of second input keys to be displayed on the second key layout screen based on an operation of through one of the plurality of first input keys, the plurality of second input keys being arranged in order to further narrow down the narrowed-down characters or symbols that can be input.
